(19) United States
(12) Patent Application Publication
(10) Pub. No.: US 2011/0226111 A1
(43) Pub. Date: Sep. 22, 2011

(54) Vinyl Composition Tile Cutter

(76) Inventors: Brian Alexander Bird, (US); Tan Nguyen, (US)

(21) Appl. No.: 12/878,899

(22) Filed: Sep. 9, 2010

Related U.S. Application Data
(60) Provisional application No. 61/276,403, filed on Sep. 11, 2009.

(51) Int. Cl. B26D 7/26; B23D 15/00

(52) U.S. Cl. 83/640; 83/694

(57) ABSTRACT

A VCT tile cutter comprises a movable top blade and a fixed bottom blade capable of shearing a VCT tile. The cutter includes a blade carrier in which the top blade can be slid horizontally in relation to the fixed position of the bottom blade beneath it. In this way, an outer edge of the top blade can be slid horizontally and positioned over a point in a tile that corresponds to the end point of a desired partial cut in the tile. When a crankshaft mechanism is activated, the blade creates a partial cut in the tile from the perimeter of the tile to a point in the tile corresponding to the location of the end of the movable blade. The blade may be straight or faceted and may have partially or completely relieved edges to enhance the capability of the cutter to perform partial cuts in the tile.

### CROSS REFERENCE TO RELATED APPLICATIONS

This application claims the benefit of U.S. Provisional Application No. 61/276,403, filed Sep. 11, 2009, which is incorporated by reference in its entirety.

### BACKGROUND

This invention relates generally to flooring tools, and in particular to vinyl composition tile cutters.

In the floor covering trade, vinyl composition tile is a common flooring for commercial applications. Vinyl composition tile is often referred to as VCT (or VCT tile), a common example being Armstrong Excelon VCT Tile. Such tile has the benefits of low materials cost, low labor cost to install, durability, and ease of cleaning. VCT tile is often installed in large rooms such as classrooms, cafeterias, supermarkets, and other commercial spaces. The VCT tile can be easily adhered directly to the concrete floors commonly found in such buildings, using low cost adhesive. The labor cost to install VCT tile is lower than ceramic tile because the tiles are precisely formed to abut each other without the need for grouting at the joints.

As shown in FIG. 12, a typical full size VCT tile 30000 is commonly manufactured to a square length L and width W of 12″×12″. In comparison with ceramic tile, VCT tile is softer and thinner. Because VCT tile is comparatively soft and thin, it can be cut using inexpensive low-carbon steel blades. Ceramic tiles by comparison must be scored with carbide wheels and broken along the score line with lever-activated pressure, or else sawed with a diamond blade,

VCT tile is cut to desired lengths in one of the following methods: VCT tile can be cut by hand by marking the desired cut on the tile with a penciled line, then scoring the line with a razor knife guided by a straight edge. After scoring, the tile can be broken along the score line by bending the tile by hand on both sides of the score line.

Alternatively, professional VCT tile cutters have been developed, such as the present day Crain No. 001 Model “A” Tile Cutter. These prior art VCT tile cutters can cut across the entire width of a VCT tile rapidly with inexpensive, low carbon steel blades, using pressure from the stroke of a crankshaft mechanism, as will be described below.

An assembled prior art VCT tile cutter 10000 is shown in FIG. 2. Prior art VCT tile cutter 10000 is used primarily to make full cuts across a full tile width as necessary to create fill tiles at the walls. The process proceeds as follows: full tiles (called “field tiles”) are positioned from the center of the room outwards in the direction of the walls. Near the wall, full field tiles normally won't fit, so it becomes necessary to cut partial tiles (called “fill tiles”) to fit to the walls. Various mechanisms for automatically positioning the tile cutter in relation to a wall surface to cut fill tiles have been developed, such as those of U.S. Pat. No. 2,619,173 to Crain, and U.S. Pat. No. 2,608,255 to Mitchell. These cutters reduce the need the measure the tile prior to cutting.

FIG. 1 is an exploded view of a prior art VCT tile cutter 10000. Tile cutter 10000 includes a base 10100. A bottom blade 10200 is fastened to the back of base 10100 with four bolts 10205. Bottom blade 10200 will be referred to as the fixed blade of the cutter, because it does not move in the cutting action of the tool. Also fastened onto the back of base 10100 is floor guide 10210. Floor guide 10210 is adjustably fastened to base 10100 with two screws 10215 which pass through left and right slots 10212, 10214. The function of the floor guide will be discussed below in a section describing use of the VCT tile cutter.

The crankshaft and blade carrier subassembly 11000 is assembled to base 10100 by first fastening the top blade 12000 onto blade carrier 12050. Top blade 12000 is fastened to blade carrier 12050 in blade carrier relief 12051 with four bolts 12055. Top blade 12000 will be referred to as the movable blade of VCT tile cutter 10000 because it moves vertically in the cutting action of the tool. Top blade 12000 has a straight bottom edge 12005 with a square left end 12007 and a square right end 12009.

Once the blade and blade carrier are assembled, a left guide 12100 is connected to base 10100 with a screw 12105. A left end of blade carrier 12050 inserts into a slot 12110 of left guide 12100. Above the left end of blade carrier 12050, a left bearing block 12120 is also inserted into slot 12110 of left guide 12100.

Crankshaft 13000 includes camshaft 13010, lever 13020, left ball bearing 13030, right ball bearing 13035, left pin 13040, and right pin 13045. Left pin 13040 and right pin 13045 insert within eccentric holes in camshaft 13010 (such as right eccentric hole 13011). Left pin 13040 inserts within slot 12110 of left guide 12100 beneath left bearing block 12120.

Right guide 12150 is positioned on a free right end of blade carrier 12050 within slot 12160. Next pin 13045 of crankshaft 13000 is inserted into slot 12160, followed by right bearing block 12125, which rests on top of pin 13045. Right guide 12150 can then be fastened to base 10100 with fastener 12155.

Left ball bearing 13030 has a flange 13031, and right ball bearing 13035 has a flange 13036. Flange 13031 of left ball bearing 13030 seats in left slot 12052 in the top surface of blade carrier 12050. Flange 13036 of right ball bearing 13035 seats in right slot 12054. The insertion of the flanges of the ball bearings into the slots on the top surface of blade carrier 12050 controls the eccentric motion of left ball bearing 13030 and right ball bearing 13035 as they pressure the top of blade carrier 12050 in the cutting action of the tool. This eccentric motion will be described below along with the discussion of the cutting action of the tool.

Left guide 12100 has a hole 12107 in the bottom of slot 12110, and right guide 12150 has a similar hole (not shown). Blade carrier 12050 has corresponding left and right holes on its bottom side (not shown) which align with the holes in the bottom of left guide 12100 and right guide 12150. Left coil spring 14005 and right coil spring 14007 insert through the holes in the bottom of the left guide 12100 and right guide 12150 and extend up into the left and right holes (not shown) of blade carrier 12050. Two pairs of pan head screws 14011, 14013 additionally fasten left guide 12100 and right guide 12150 to base 10100 through back side holes (not shown) in base 10100. The inner of each pair of pan head screws 14011, 14013 passes directly underneath the hole in the bottom of the left guide 12100 and right guide 12150, each creating a footing for left coil spring 14005 and right coil spring 14007. Left coil spring 14005 and right coil spring 14007 pressure blade carrier 12050 upward within slots 12110, 12160 in left guide 12100 and right guide 12150

Because the blade carrier 12050 is constantly pressured upwards by left coil spring 14005 and right coil spring 14007, it causes lever 13020 to rotate backwards (clockwise). A leg 13025 formed by an extension of lever 13020 through the back of camshaft 13010 contacts the back of blade carrier 12050. This creates a stop for lever 13020 at a vertical position. At the stop, the vertical position of lever 13020 also corresponds to a high point or starting position of top blade 12000.

Left set screw 15011 and right set screw 15013 work against left coil spring 14005 and right coil spring 14007 to set a starting height and shear angle of the movable upper blade 12000. Left set screw 15011 and right set screw 15013 bear on left bearing block 12120 and right bearing block 12125. Turning left set screw 15011 or right set screw 15013 causes left pin 13040 or right pin 13045 of crankshaft 13000 to move up or move down.

If both left set screw 15011 and right set screw 15013 are turned by equal amounts, blade carrier 12050 and top blade 12000 are moved straight up or down. However, for ease of cutting, a “shear angle” in the cutting action of top blade 12000 is preferred. A shear angle is an orientation of the top blade 12000 where, in its starting position, the space between top blade 12000 and bottom blade 10200 on the right side is 2-3 times the space on the left side. A shear angle on the blade causes the blade to cut only a small portion of the tile as lever 13020 is being turned. This reduces the force necessary to be applied on lever 13020 as the tile is being cut. To produce the shear angle, left set screw 15011 only can be turned such that the gap on the opposite right side is a preferred 2-3 times that on the left side.

Left guide 12100 is fitted with left ball caster 12115, and right guide 12150 is fitted with right ball caster 12165. Left ball caster 12115 and right ball caster 12165 facilitate lateral movement of the tile cutter when used with the floor guide 10210 (discussed below).

To make a cut, a user marks a line the full length across a tile, and places it on bed surface 10105 of base 10100. The user positions a right edge of the tile against a fence 10110. The fence 10110 squares the tile to top blade 12000 and bottom blade 10200. The user aligns the marked line with the line of top blade 12000 and pulls lever 13020 downward. This causes camshaft 13010 to be turned. The eccentric positioning of left pin 13040 and right pin 13045 rotates left ball bearing 13030 and right ball bearing 13035 forward and down, causing blade carrier 12050 to be pressured downwards. This causes the movable top blade 12000 to pressure the tile against fixed bottom blade 10200, thereby shearing the tile. Afterwards, the user releases lever 13020, and it returns to a vertical position. In the same motion, top blade 12000 also returns to a starting position.

A tile guide 15000 can be fastened to fence 10110 with thumbscrew 15005 to make multiple cuts of a fixed width. A floor guide 10210 provides an alternative automatic measuring system. Floor guide 10210 forms a vertically adjustable lip which can work as a stop below base 10100 capable of positioning the blades of the cutter in line with the edge of the last full field tile. When floor guide 10210 is used, a full tile is placed on the bed surface 10105 and slid underneath top blade 12000 until it abuts a wall. With the cutter in this position, the blades will automatically cut a fill tile for the proper width at that particular location.

The assembled prior art VCT tile cutter 10000 is shown in FIG. 2. The top blade 12000 extends across the entire opening 16000 through which a VCT tile may be placed for cutting. In fact, the left end 12007 (FIG. 1) and right end 12009 (FIG. 1) of top blade 12000 extend all the way into the slot 12110 of left guide 12100 and slot 12160 of right guide 12150. As a result, top blade 12000 can only make a straight cut across an entire width (chord) of a VCT tile that is placed beneath it.

Prior art VCT tile cutter 10000 is mainly useful to make straight cuts across an entire width of a tile, as needed to cut fill tile needed along straight walls. However, wall surfaces form many other shapes. One example is the shape of outside corners. In such case, as shown in FIG. 13, a rectangular-shaped cutout 31005 is needed in the VCT tile 31000. To make such a cut requires a first cut 31015 followed by a second cut 31025. First cut 31015 and second cut 31025 are partial cuts across VCT tile 31000. The prior art VCT tile cutter of FIG. 2 cannot make such cuts.

Another example of a situation where partial cuts in the VCT tile are needed is for “U-shaped” cutout shown in FIG. 14. Two tiles with “U-shaped” cutouts are often needed at the threshold of a doorway. The “U-shaped” cutout 32005 in VCT tile 32000 requires a first cut 32015, a second cut 32025, and a third cut 32035. First cut 32015, second cut 32025, and third cut 32035 are all partial cuts in VCT tile 32000. The prior art VCT tile cutter of FIG. 2 cannot make such cuts.

To make the partial cuts shown in FIGS. 13 and 14, the flooring installer will normally mark the desired cutout in the tile using a pencil and framing square. Afterwards, the installer will score the desired cutout using the framing square and a razor knife. After scoring, the VCT tile will normally snap evenly along the scored lines by bending the tile across the scored line with careful hand pressure.

However, VCT tile can be brittle, particularly when it is held in storage for an abnormally long period of time, or whenever it is being installed in cold weather. In such cases, the VCT tile cracks often cracks unpredictably beyond the score lines. In such cases, the flooring installer often has to pre-heat the tile with a powerful heat gun. The preheating process, often to referred to as a “hot cut” in the trade, adds additional labor cost.

In general, the labor involved in cutting tiles to fit corners areas, doorways, and other areas can be one of the more costly aspects of the installation. Most of the cuts required to fit tiles in these areas involve partial cuts in the VCT tile, but the prior art VCT tile cutter cannot make such cuts.

A VCT tile cutter that could make partial cuts in the VCT tile could speed up the process of making rectangular cutouts, “U-shaped” cutouts, or other cutouts requiring partial cuts in the tile. A VCT tile cutter that could make partial cuts in the VCT tile, while still being able to make the straight cuts across the entire tile as required at walls, would have greater utility, and could help reduce labor cost.

### SUMMARY

Embodiments of the invention comprise a VCT tile cutter with a movable top blade and a fixed bottom blade that shears a tile with a crankshaft mechanism. In addition, the cutter includes a blade carrier enabling the top blade to be slid horizontally in relation to the fixed position of the bottom blade beneath it.

In one embodiment, the blade carrier component includes an added slot. The top blade includes an added slideable member insertable in the slot. The slideable member slides within the slot, enabling the top blade to be slid horizontally (i.e., in a direction transverse to the cutting direction that is generally parallel to a cutting edge of the top blade) while being fixed in the direction of cutting.

In another embodiment, a blade carrier assembly comprises several components, including a first blade carrier component and a second blade carrier block component. The blade carrier component is slideably mounted to a fixed, blade carrier block component. A top blade is fixedly attached to the blade carrier component. However, the top blade can be slid horizontally along with the slideable blade carrier component.

With either of the embodiments, an outer edge of a top blade can be slid horizontally and positioned over a point in the tile which corresponds to the end point of a desired partial cut in the tile. The lever is activated and the blade will create a partial cut in the tile from the perimeter of the tile to a point in the center of the tile corresponding to the location of the end of the movable blade.

Embodiments of the invention additionally include faceted blade shapes enhancing the capability of the cutter to perform partial cuts in the tile. In one embodiment, the blade has a straight edge in a center area, similar to that of the prior art top blade, but additionally includes one or more relieved edges at either end of the blade. These partially relieved edges at the end of the blade produce a small scored area at the end of partial cut in the tile, corresponding to the relieved area at the end of the blade. This scored area can be broken after the cutting operation with light hand pressure. This prevents the undesirable cracking created by the prior art square-end top blades (such as top blade 12000 of FIGS. 1 and 2), particularly when VCT tiles are unusually brittle.

Alternatively, the top blade may be completely relieved from a point in the center of the blade, all the way out to left and right ends of the blade. Such a completely relieved blade is capable of cutting a tile from a point in the center of the tile outward to the perimeter of the tile. Such a blade can make the center cut of a “U-shaped” cutout (cut 32035 of “U-shaped” cutout 32005 in FIG. 14).

### BRIEF DESCRIPTION OF THE DRAWINGS

FIG. 1 is an exploded view of a prior art VCT tile cutter.

FIG. 2 is a perspective view the prior art VCT tile cutter of FIG. 1.

FIG. 3 is a perspective view of a VCT tile cutter, in accordance with an embodiment of the invention.

FIG. 4 is an end view of the blade carrier for a VCT tile cutter, in accordance with an embodiment of the invention.

FIG. 5 is a side view of a blade assembly for a VCT tile cutter, in accordance with an embodiment of the invention.

FIG. 6 is a front view of a blade assembly for a VCT tile cutter, in accordance with an embodiment of the invention.

FIG. 7 is a front view of a blade assembly having relieved edges, in accordance with an embodiment of the invention.

FIG. 8 is a front view of a blade assembly having fully relieved edges, in accordance with an embodiment of the invention.

FIG. 9 is a perspective view of a VCT tile cutter with an alternative blade carrier design, in accordance with an embodiment of the invention.

FIG. 10 is a partial view of the blade carrier block and slideable blade carrier for the VCT tile cutter of FIG. 9.

FIG. 11 is a front view of that the VCT tile cutter of FIG. 9 showing how the blade carrier slides in either direction, in accordance with an embodiment of the invention.

FIG. 12 is a perspective view of a VCT tile.

FIGS. 13 and 14 are perspective views of the VCT tile having different portions cut away therefrom.

FIG. 15 is a front view of the VCT tile cutter of FIG. 3 including a top blade with an extension beyond both right and left guides for ease of positioning the top blade for a partial cut.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

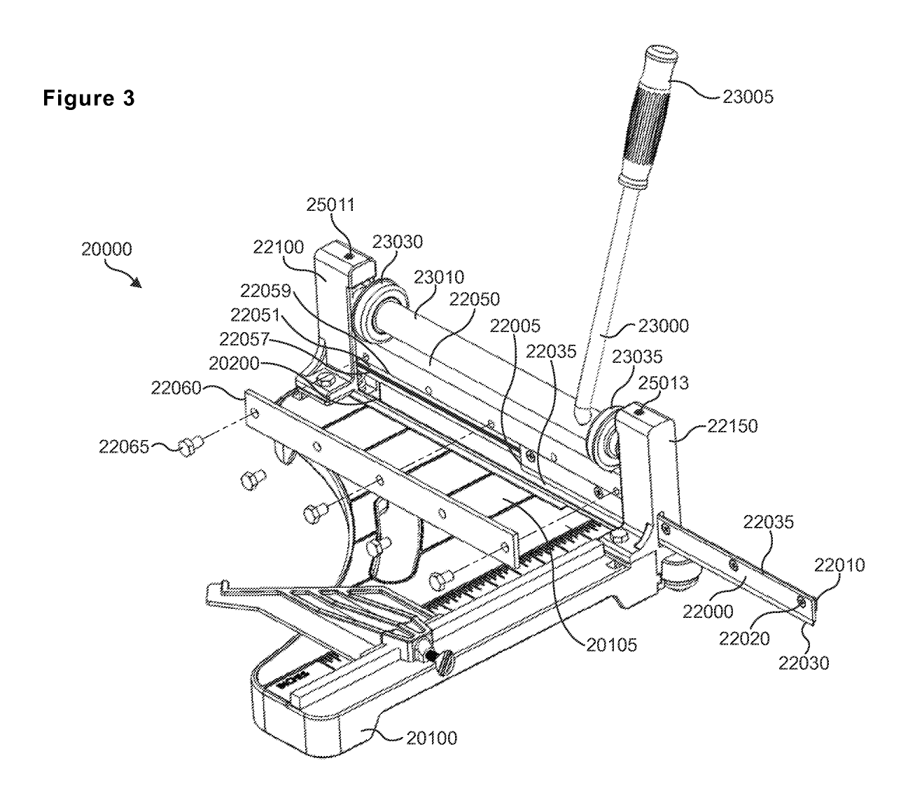

As shown in FIG. 3, VCT tile cutter 20000 is one embodiment of the present invention. VCT tile cutter 20000 includes several elements of the prior art VCT tile cutter, including the base 20100, fixed bottom blade 20200, left guide 22100, right guide 22150, crankshaft 23000, left ball bearing 23030, right ball bearing 23035, and blade carrier 22050. Just as with the prior art VCT tile cutter, blade carrier 22050 is spring loaded with two coil springs (not shown) that pressure two eccentric pins (not shown) in the camshaft 23010 against two bearing blocks (not shown) held within the internal slots of left guide 22100 and right guide 22150. Just as with the prior art VCT tile cutter, left set screw 25011 and right set screw 25013 adjust the beginning height and shear angle of the movable top blade 22000.

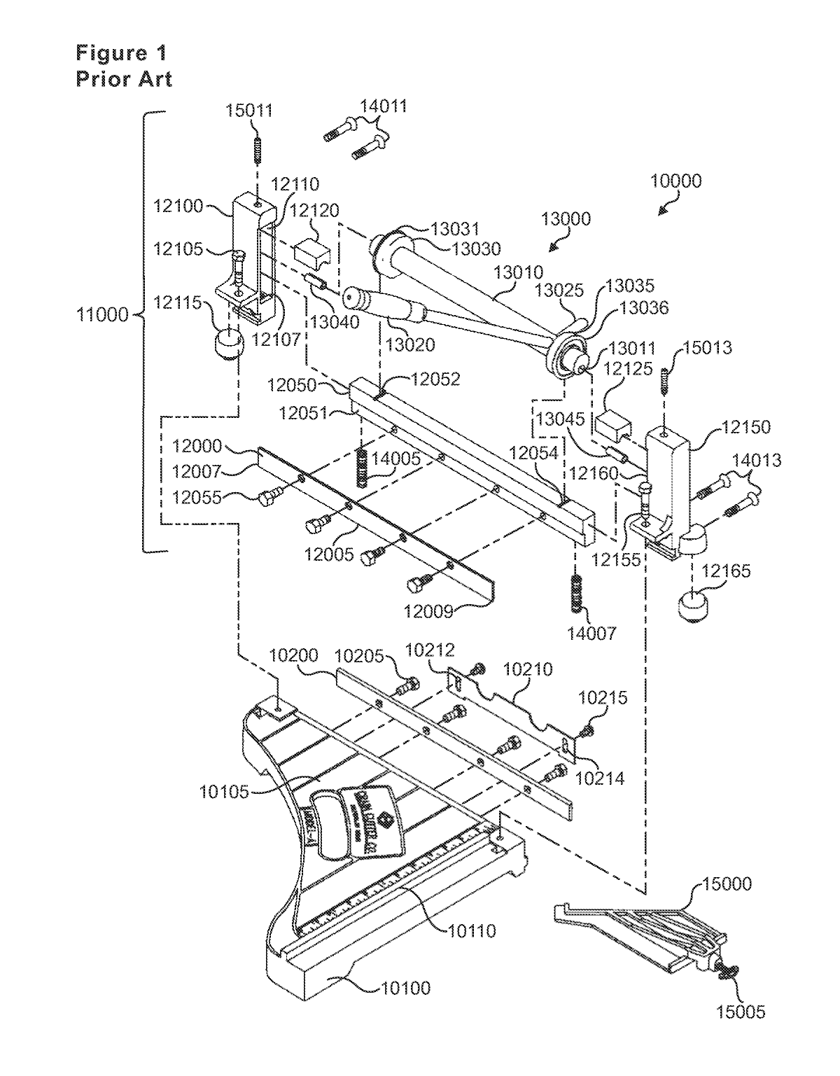

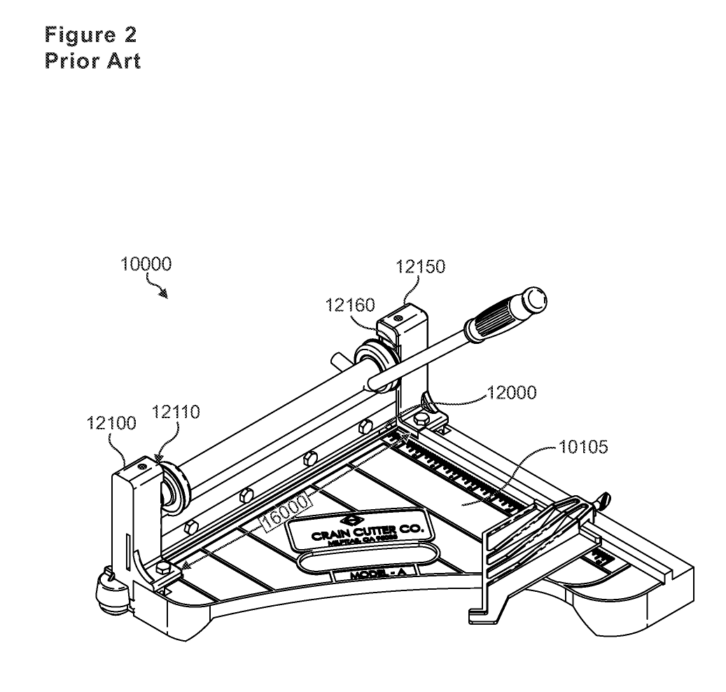

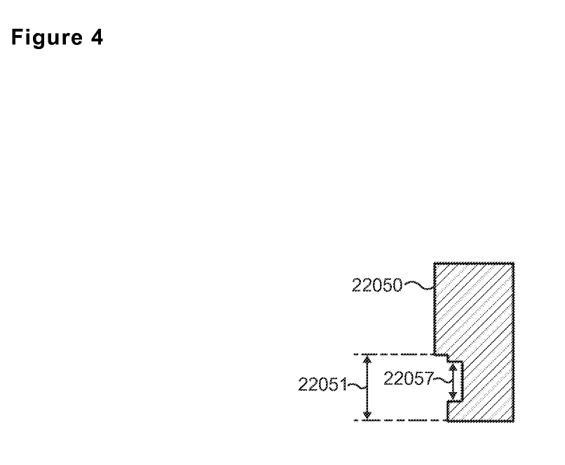

The blade carrier 22050 of VCT Tile Cutter 20000 includes an added slot 22057 in the area of the blade carrier relief 22051. The prior art VCT Tile Cutter 10000 of FIG. 1 includes blade carrier relief 12051, but has no slot such as slot 22057 (FIG. 3). FIG. 4 is an end view of blade carrier 22050 showing more clearly the area of slot 22057 within blade carrier relief 22051. Slot 22057 is rectangular in shape.

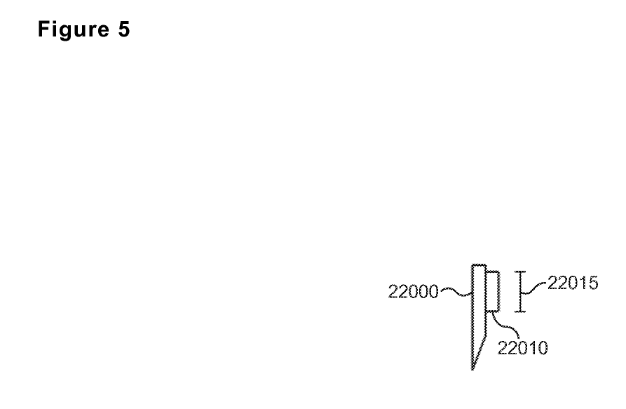

The top blade 22000 includes an added slideable member 22010 attached with four screws 22020 to the back side of top blade 22000. Slideable member 22010 has a rectangular profile that is insertable within slot 22057 of blade carrier 22050 and slideable within slot 22057. FIG. 5 is an end view of the top blade 22000 including an attached slideable member 22010 that is rectangular in profile.

As shown in FIG. 3, cover 22060 fastens onto blade carrier 22050 with five bolts 22065. Cover 22060 slideably holds blade 22000 against blade carrier relief 22051, while also keeping slideable member 22010 within slot 22057.

As shown in FIG. 5, the height 22015 of slideable member 22010 is slightly shorter than the height designated by the dimension of slot 22057 (FIG. 4). As shown in FIG. 3, this is so that when a bottom cutting edge 22030 of top blade 22000 is pressured against a tile to be cut, vertical play between the slidable member 22010 and slot 22057 causes a top surface 22035 of top blade 22000 to bear against the overhang 22059 of blade carrier relief 22051. This ensures that most of the pressure required to cut the VCT tile is applied by overhang 22059. Otherwise, the thin slideable member 22010 or slot 22057 could be deformed over time, rendering top blade 22000 unable to slide as desired.

In the embodiment of FIG. 3, slot 22057 is a rectangular slot, and slideable member 22010 has a rectangular profile that is slideable within slot 22057. However, slot 22057 could be any shape which could accept a slideable member of a corresponding shape.

Conversely, the slideable member itself may be formed in other profiles, such as a “T-shape”. A “T-shaped” profile for the slideable member would require a corresponding “T-shaped” cutout (slot) in the blade carrier. Such would hold the blade on the blade carrier without the need for cover 22060.

However, a rectangular shape for the slot 22057 is preferred because it can be formed with conventional milling cutters. Furthermore, a corresponding rectangular profile for slideable member 22010 is preferred because it can be formed inexpensively as a sheet metal stamping. Cover 22060 is also a rectangular shape that can be formed inexpensively as a sheet metal stamping.

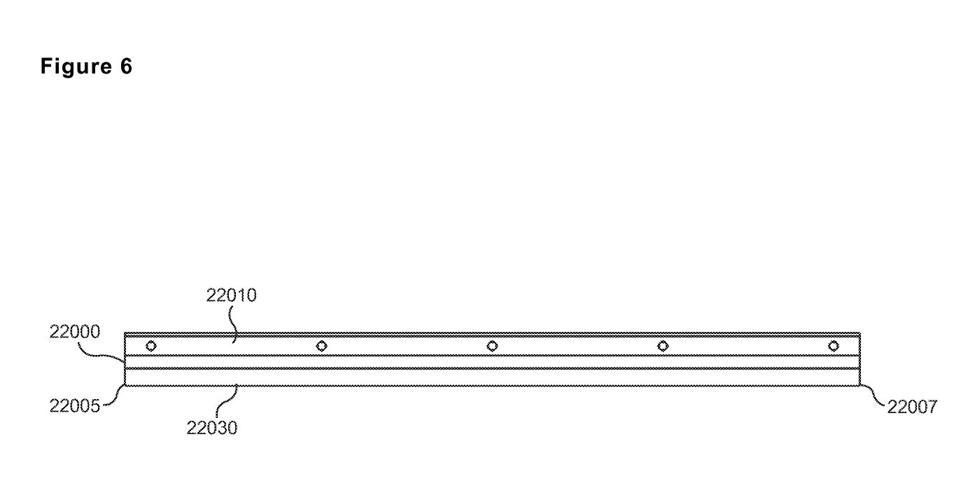

Furthermore, the slideable member may be formed from several pieces of material which are spaced apart, rather than a single lengthy piece of material such as the slideable member 22010 (FIG. 6). Any element which is slideable within an added slot in the blade carrier component will be referred to herein as a slideable member.

As shown in FIG. 3, top blade 22000 is slideable horizontally in relation to the fixed bottom blade 20200. Top blade 22000 may be slid horizontally to the right or to left. In FIG. 3, top blade 22000 is slid to the right, with end 22005 at a point midway above fixed bottom blade 20200. A VCT tile may be placed on bed surface 20105 and pushed forward through opening 22035 between the top blade 22000 and bottom blade 20200. Afterwards, when the handle 23005 of crankshaft 23000 is pulled, top blade 22000 will make a partial cut in the tile up the left end 22005 of top blade 22000.

The embodiment of FIG. 3 includes a top blade 22000 with a straight bottom edge 22030. FIG. 6 shows a back view of top blade 22000 including a slideable member 22010, straight bottom edge 22030, left end 22005 and right end 22007. Top blade 22000 of FIGS. 3 and 6 will be referred to herein to as a “straight blade”, because the bottom cutting edge 22030 is straight across the entire blade. Furthermore, the ends of top blade 22000 at left end 22005 and right end 22007 are square, similar to top blade 12000 of prior art VCT tile cutter 10000 (FIG. 1).

If the VCT tile is unusually brittle, the square corners at left end 22005 and right end 22007 on top blade 22000 (FIG. 6) may leave small cracks beyond the end of a partial cut. This is due to the sharp, square corners formed at the end of a cut by a straight blade. As will be discussed below, other blade embodiments may include alternative top blades including relieved edges reducing this problem of cracking.

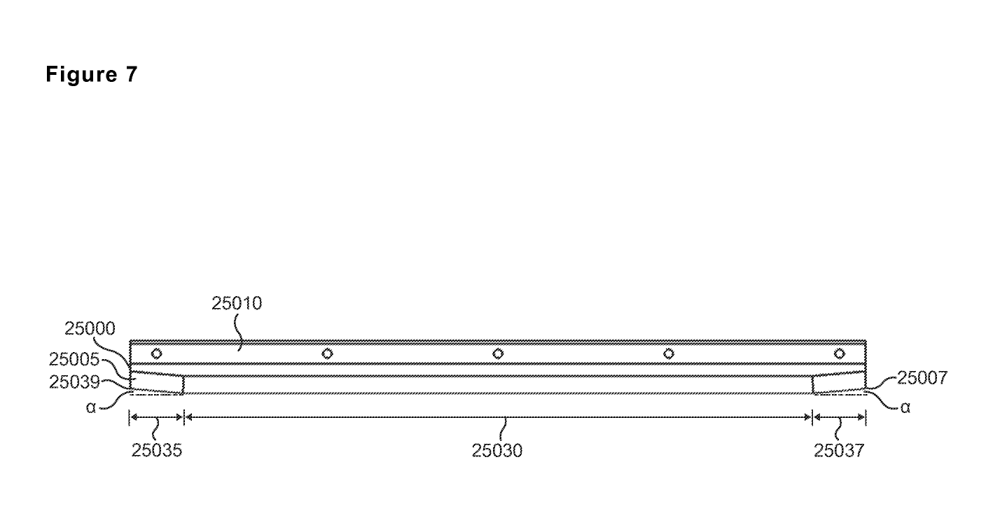

As shown in FIG. 7, top blade 25000 includes a slideable member 25010, a central edge 25030 which is straight, a left relieved edge 25005, and a right relieved edge 25007. Top blade 25000 of FIG. 7 will be referred to herein as a “partially relieved blade”, because at least a portion of the bottom cutting edge of the blade is straight (not relieved).

At any area beneath the straight central edge 25030, top blade 25000 will tend to cut the VCT tile all the way through. However, along the left relieved area 25035 or right relieved area 25037, top blade 25000 will tend to score or partially cut the VCT tile rather than cut all the way through. When the tile is removed from the cutter, any small scored areas that remain can be safely snapped by hand pressure. This prevents the undesirable cracking which can sometimes occur beyond the end of a partial cut in a VCT tile when straight blade 22000 (FIG. 3) is used.

As shown in FIG. 7, the angle alpha that left relieved edge 25005 and right relieved edge 25007 form with the straight central edge 25030 is preferably between 2 and 10 degrees. However this angle could be any relieved angle producing a score at the end of a partial cut being performed by the top blade, rather than a cut all the way through the tile.

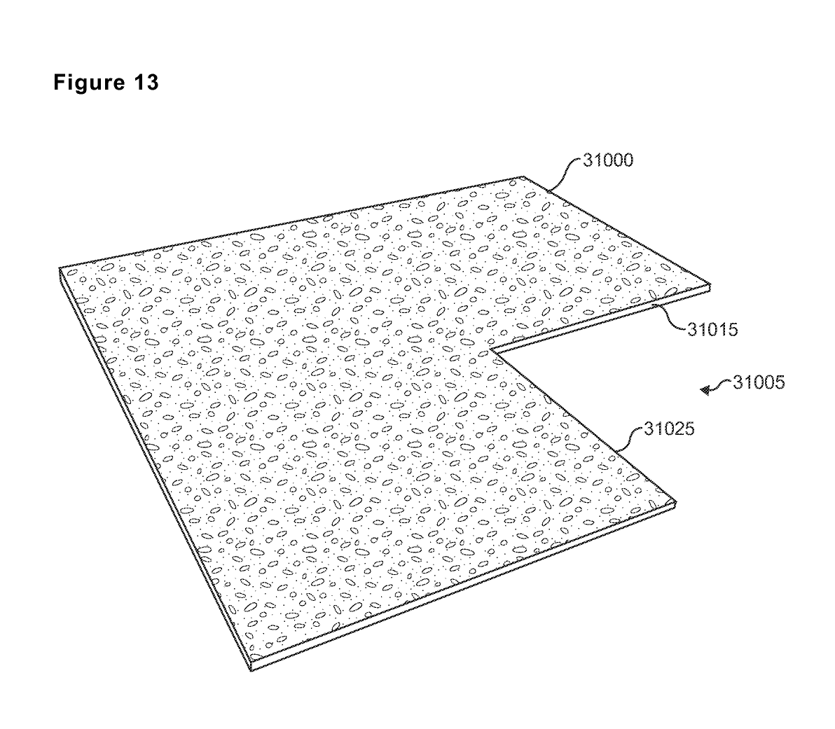

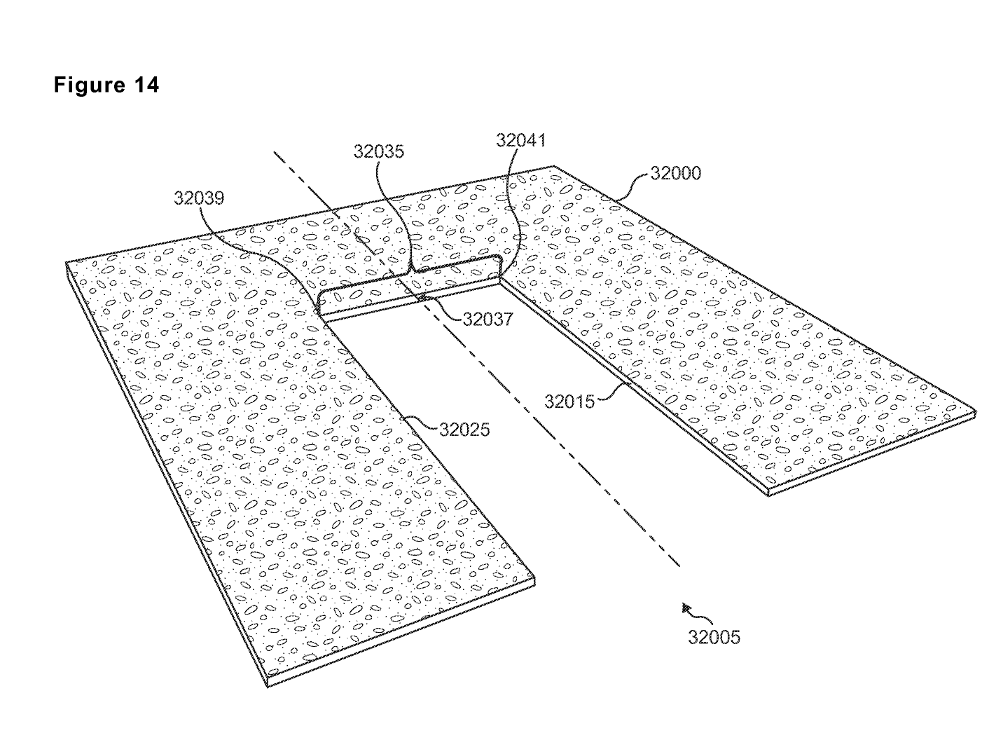

Top blade 22000 of FIG. 6 and top blade 25000 of FIG. 7 can make partial cuts in a VCT tile from the perimeter of the tile inwardly to a midpoint in the tile. This is useful to make square cutouts, such as square cutout 31005 in VCT tile 31000 of FIG. 13. However, top blade 22000 (FIG. 6) and top blade 25000 (FIG. 7) cannot make a partial cut from a point in the center of the tile outward, as would be required for cut 32035 of the “U-shaped” cutout 32005 in VCT tile 32000 (FIG. 14).

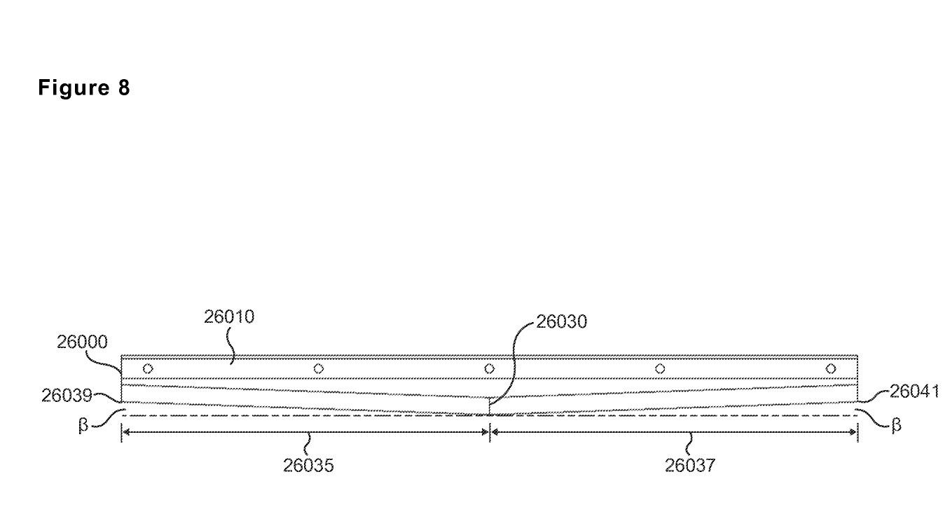

As shown in FIG. 8, top blade 26000 includes a slideable member 26010, a left relieved area 26035, and a right relieved area 26037. Left relieved area 26035 is relieved at an angle beta of about 2 degrees from a center point 26030 all the way out to a left end 26039. Similarly, right relieved area 26037 is relieved at the same angle beta of about 2 degrees from a center point 26030 all the way out to a right end 26041. Top blade 26000 of FIG. 8 will be referred to herein as a “fully relieved blade”, because the blade is relieved from a center point all the way out to both ends on both left and right sides of the blade.

The fully relieved top blade 26000, with its long left relieved area 26035 and right relieved area 26037 from center 26030, can cut the VCT tile from a point in the center of the tile outward. As shown in FIG. 14, to make cut 32035 of in VCT tile 32000, center 26030 (FIG. 8) of fully relieved blade 26000 is positioned at the midpoint 32037 of cut 32035. As shown in FIG. 14, the relieved edges will cut the VCT tile outwardly from the midpoint 32037 outwards to left end 32039 and right end 32041 of cut 32035.

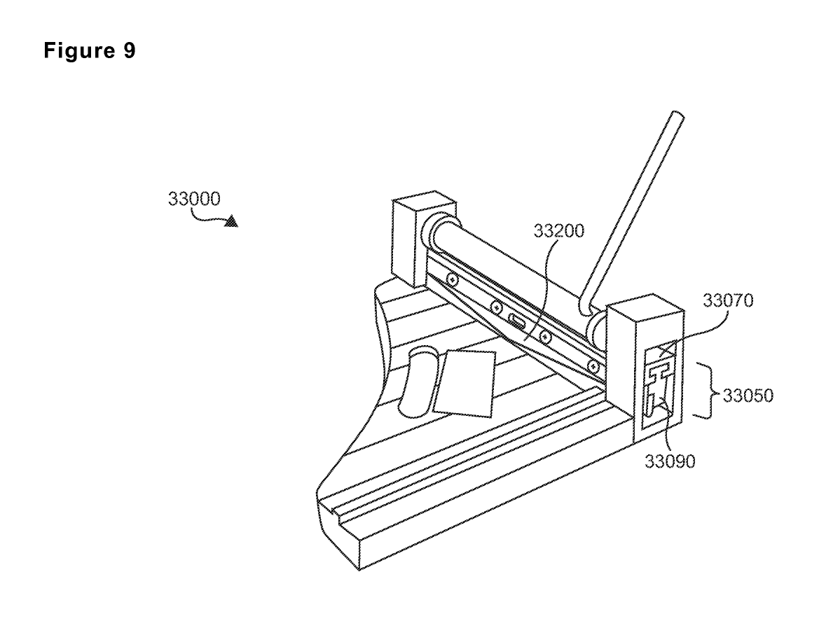

Another embodiment including an alternative blade carrier comprising several components is shown in FIG. 9. VCT tile cutter 33000 has a blade carrier 33050 comprised of a first blade carrier block 33070 and a second slideable blade carrier 33090. A top blade 33200 is fixedly fastened to slideable blade carrier 33090.

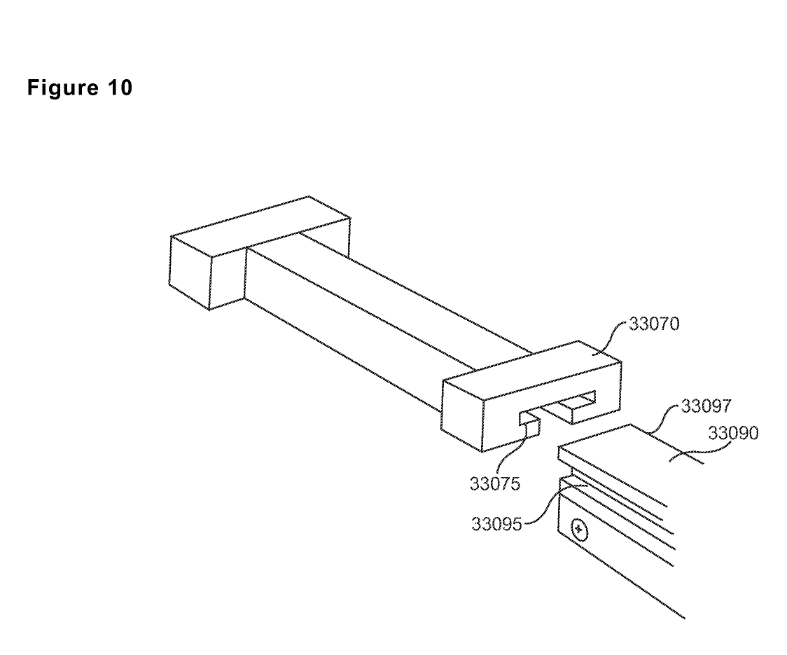

In FIG. 10, the blade carrier block 33070 and a portion of the slidable blade carrier 33090 are shown in isolation. Blade carrier block 33070 includes a “T-shaped” slot 33075. Slideable blade carrier 33090 includes a front slot 33095, and a rear slot 33097 (not visible, but similar to front slot 32095). The profile of the top of slideable blade carrier 32090 is “T-shaped” and insertable into the “T-shaped” slot 33075 of blade carrier block 33070.

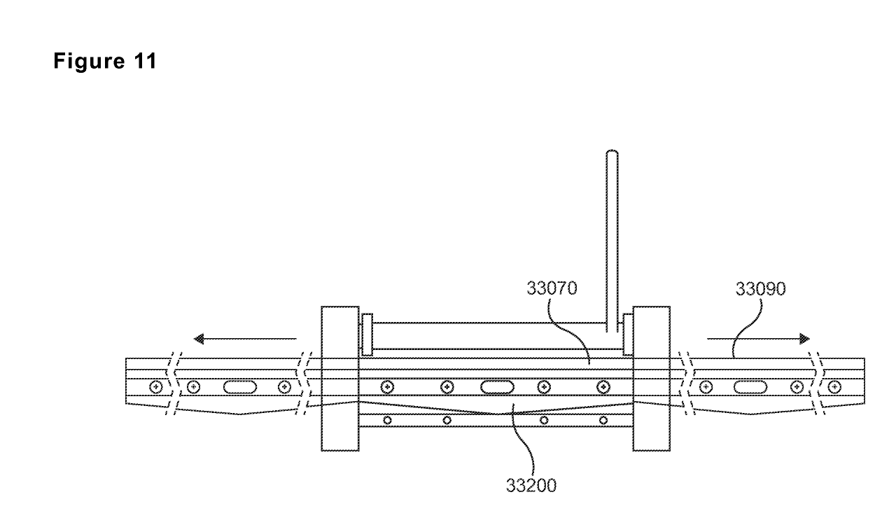

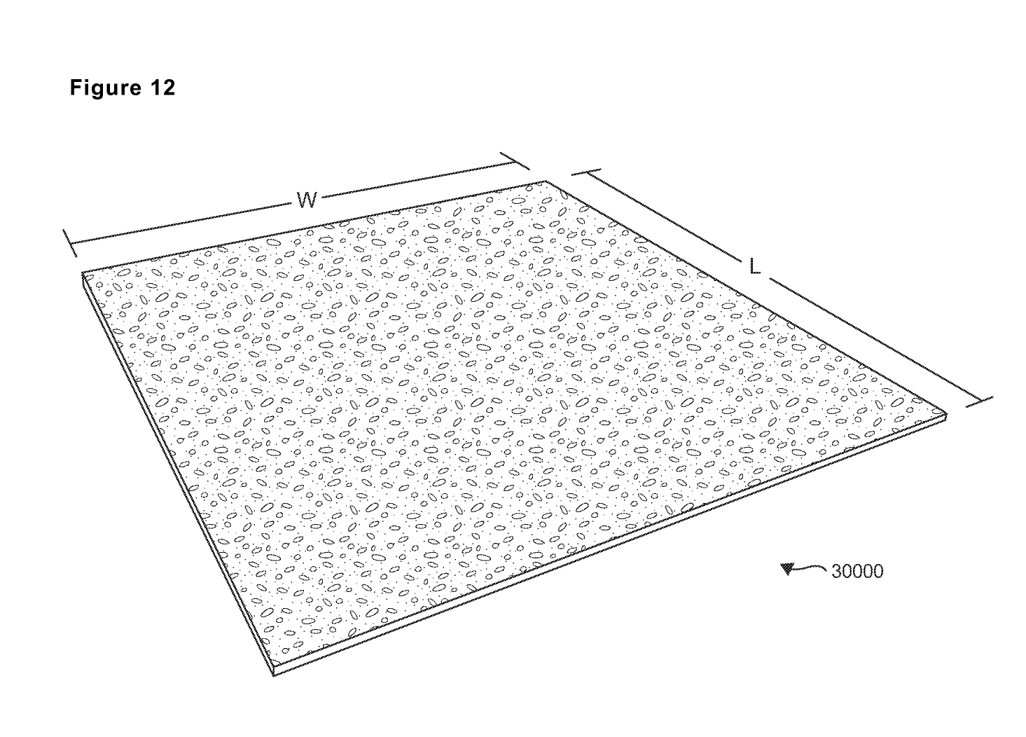

As shown in FIG. 11, slideable blade carrier 33090 can slide horizontally to the left or to the right within blade carrier block 33070. Thus, an end of the blade 33200 can be positioned at a point midway over a VCT tile to make a partial cut in the tile. As shown in FIG. 9, top blade 33200 is a fully relieved blade. However, any of the blades discussed herein could be fixedly mounted onto slideable blade carrier 33090, including a straight blade, or a partially relieved blade.

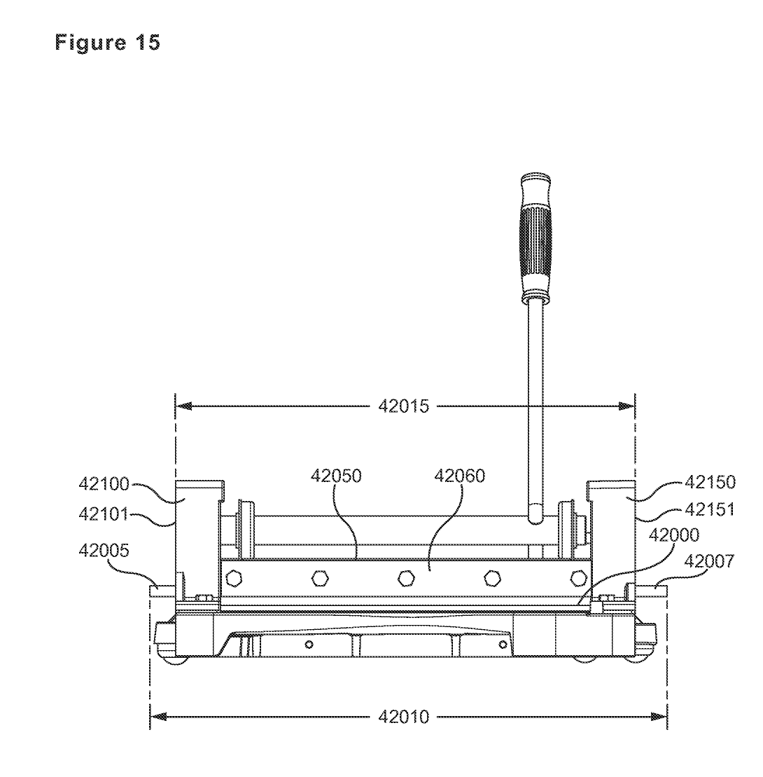

Another embodiment of the top blade facilitating partial cuts in a VCT tile is shown in FIG. 15. VCT tile cutter 40000 is similar to VCT tile cutter 20000 of FIG. 3, including a blade carrier 42050 having a slot (not shown), a top blade 42000 including a slideable member (not shown) insertable into the slot, and a cover 42060. Top blade 42000 additionally has an extended length 42010. Length 42010 allows top blade 42000 to extend beyond a distance 42015 from an outside wall surface 42101 of left guide 42100 to an outside wall surface 42151 of right guide 42150. This ensures that an end of top blade 42000 is always accessible for a user to grasp top blade 42000. A user may grasp a top blade 42000 at either end surface 42005 or 42007, in order to position either end of the cutting edge (the ends being concealed within left guide 42100 and right guide 42150 in this view) over a VCT tile in order to make a partial cut in a VCT tile.

In another alternative, the top blade includes a slot, and the blade carrier includes features such as pins or bosses insertable into the slot in the top blade, such that the top blade is slideable on the features of the blade carrier.

In another alternative, the top blade includes a slot or a relief, and the blade carrier, or the cover attachable to the blade carrier, includes a feature such as a boss or a rib insertable into the slot or relief of the top blade, such that the slot or relief on the top blade is slideable on the boss or rib on the blade carrier, or the cover.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although discussed in terms of a cutter for VCT tiles, embodiments of the cutter may be designed for other types of materials that are relatively soft, such as cork or rubber, as opposed to hard tiles such as ceramic.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A vinyl composition tile cutter comprising:
a base for supporting a vinyl composition tile;
a blade carrier including a slot, the blade carrier movable in a cutting direction that is towards the base; and
a top blade including a slideable member insertable into the slot of the blade carrier, the top blade slidable in a direction transverse to the cutting direction, wherein an end of the top blade is slideable over the base and capable of making a partial cut in a vinyl composition tile supported by the base when a vinyl composition tile is placed on the base.

2. The vinyl composition tile cutter of claim 1, wherein the slot is formed in a relief area in the blade carrier.

3. The vinyl composition tile cutter of claim 1, where the slot in the blade carrier is a rectangular slot, and a profile of the slideable member of the top blade insertable into the slot in the blade carrier is rectangular.

4. The vinyl composition tile cutter of claim 1, further comprising:
a cover fastenable to the blade carrier, wherein, when fastened to the blade carrier, the cover retains the slideable member in the slot.

5. The vinyl composition tile cutter of claim 1, where the slot in the blade carrier is a “T-shaped” slot, and the slideable member of the blade has a “T-shaped” profile.

6. The vinyl composition tile cutter of claim 1, wherein the top blade includes at least one relieved edge.

7. The vinyl composition tile cutter of claim 1, wherein the top blade has two fully relieved edges.

8. The vinyl composition tile cutter of claim 1, wherein the length of the top blade is greater than a distance between two outside wall surfaces of a left and right guide of the vinyl composition tile cutter.

9. The vinyl composition tile cutter of claim 1, further comprising:
a bottom blade fixed to the base and opposite the top blade when the top blade is inserted into the blade carrier.

10. The vinyl composition tile cutter of claim 1, further comprising:
a crankshaft mechanism configured to move the blade carrier towards the base upon actuation of the crankshaft mechanism.

11. A vinyl composition tile cutter comprising;
a base for supporting a vinyl composition tile;
a blade carrier block;
a blade carrier slideably insertable into the blade carrier block;
a top blade mountable on the blade carrier;
wherein, when the top blade is mounted on the blade carrier, an end of the top blade is slideable over the base and capable of making a partial cut in a vinyl composition tile supported by the base.

12. The vinyl composition tile cutter of claim 11, wherein the top blade includes at least one relieved edge.

13. A vinyl composition tile cutter comprising:
a base for supporting a vinyl composition tile;
a blade carrier movable in a first, cutting direction that is towards the base and capable of positioning a top blade in a second, transverse direction to the cutting direction to a plurality of transverse positions when a top blade is mounted on the blade carrier; and
wherein different transverse positions of a top blade result in different lengths of a cut made into a vinyl composition tile when a vinyl composition tile is placed on the base and a top blade is moved in a cutting direction into a vinyl composition tile.

14. A blade for a vinyl composition tile cutter including at least one relieved edge.

15. The blade of claim 14, additionally including a slideable member that is slideably insertable into a slot in a blade carrier of the vinyl composition tile cutter.

16. The blade of claim 14, wherein the blade includes at least one fully relieved edge.

17. A blade for a vinyl composition tile cutter wherein the length of the blade is greater than a distance between two outside wall surfaces of a left and right guide of the vinyl composition tile cutter.
